(19) United States
(12) Patent Application Publication
(10) Pub. No.: US 2026/0170838 A1
(43) Pub. Date: Jun. 18, 2026

(54) IMAGE-BASED ERROR IDENTIFICATION AND REMEDIATION WITH LANGUAGE MODEL

(71) Applicant: Maplebear Inc., San Francisco, CA (US)

(72) Inventors: Prithvishankar Srinivasan, Seattle, WA (US); Joseph Olivier, San Bruno, CA (US); Shishir Kumar Prasad, San Ramon, CA (US); David Hsu, Oakland, CA (US)

(21) Appl. No.: 18/986,577

(22) Filed: Dec. 18, 2024

(51) Int. Cl. G06V 20/52; G06F 11/07; G06Q 30/016; G06V 10/774; G06V 20/62; G06V 30/10

(52) U.S. Cl. CPC G06V 20/52; G06F 11/0709; G06F 11/0784; G06F 11/0793; G06Q 30/016; G06V 10/774; G06V 20/62; G06V 30/10

(57) ABSTRACT

A system for image-based error identification and remediation receives, from a computing device, a request to identify errors with a completed order and image data including one image captured by a camera assembly. The system applies a feature extraction model to the image to identify image features describing an item from the completed order. The system generates a prompt including the image features and instructions to identify any errors with the item from the completed order. The system causes execution of the prompt by a language model trained as a machine-learning model to perform error identification based on image features. The system receives a response generated by the language model indicating errors identified from the image features. The system, responsive to error identification, selects candidate remedial actions to resolve the identified errors. The system performs one remedial action to resolve the errors identified by the language model.

### BACKGROUND

An online system hosts an online platform for connecting orders by users and to pickers for servicing. Orders include items to be obtained from one or more source locations. Once an order is collected and delivered to the user, the completed order may have one or more perceived errors, in the perspective of the user. The user identifies that the order is errant to the online system, further requesting the online system to remediate. The conventional error remediation process can sometimes involve several steps to identify the specific error, to validate the identified error, to determine remediation steps, and then to enact such steps. The process is robust in part to prevent fraudulent reporting of errors by bad actors. However, sometimes these steps can create friction with well-intentioned users.

Moreover, the user-driven error reporting follows after order completion, which may limit the possible remedies to the user. For example, if an incorrect item is obtained by a picker at the source location, and that order is delivered, this limits the remedial actions to resolve the incorrect item obtained.

For these various reasons, the frictional process creates a technical challenge in the computational burden of processing, verifying, and remediating errors in orders, in a robust manner that catches fraudulent error reports, while streamlining good-faith order issues.

### SUMMARY

In accordance with one or more aspects of the disclosure, a system for image-based error identification and remediation is disclosed. The system receives, from a computing device, a request to report errors with a completed order and image data including one image captured by a camera assembly. The system applies a feature extraction model to the image to identify image features describing an item from the completed order. The system generates a prompt including the image features and instructions to identify any errors with the item from the completed order. The system causes execution of the prompt by a language model trained as a machine-learning model to perform error identification based on image features. The system receives a response generated by the language model indicating errors identified from the image features. The system, responsive to error identification, selects candidate remedial actions to resolve the identified errors. The system performs one remedial action to resolve the errors identified by the language model.

Leveraging the language model for image-based error identification or remedial action suggestion injects automation in the error processing workflow, thereby compacting the number of touchpoints to identify the errors. Implementing an autonomous agent to perform the needed remedial actions further add to the automation of the error-processing workflow. Moreover, identifying recurrent error types empowers the system to employ preventative measures to prophylactically address errors before they order delivery.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 illustrates an interaction diagram describing the process of image-based error identification and, optionally, remediation, in accordance with one or more embodiments.

FIG. 4 illustrates an interaction diagram describing the process of image-based error verification and, optionally, remediation, in accordance with one or more embodiments.

FIG. 5 illustrates a flowchart of the process of image-based error identification and, optionally, remediation, in accordance with one or more embodiments.

### DETAILED DESCRIPTION

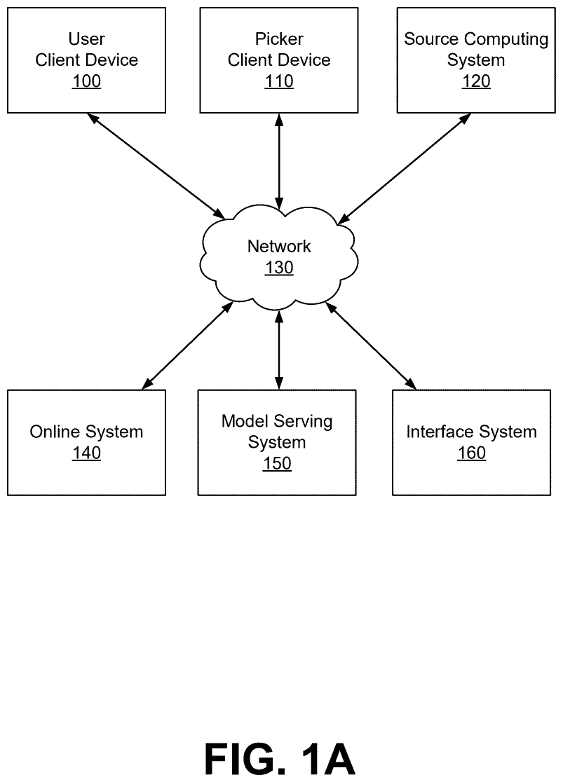

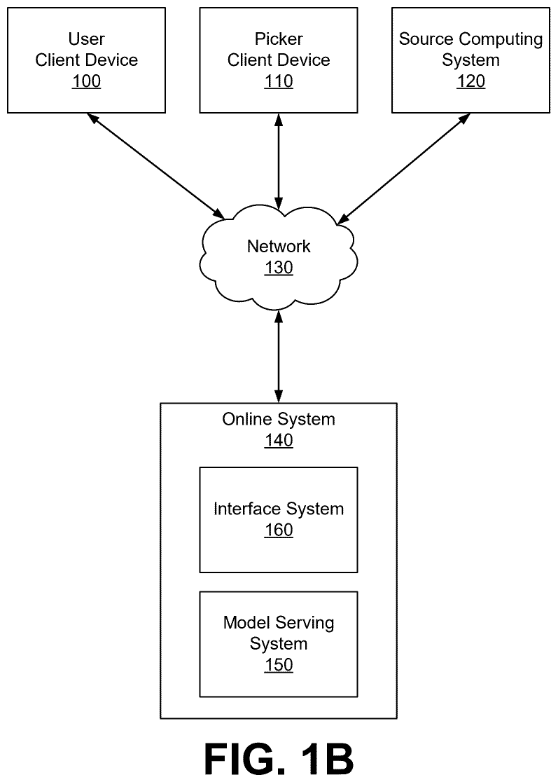

FIG. 1A illustrates an example system environment for an online system 140, in accordance with one or more embodiments. The system environment illustrated in FIG. 1A includes a user client device 100, a picker client device 110, a source computing system 120, a network 130, and an online system 140. Alternative embodiments may include more, fewer, or different components from those illustrated in FIG. 1A, and the functionality of each component may be divided between the components differently from the description below. In one or more example implementations, there may be an additional client device in use by a reviewer. Additionally, each component may perform their respective functionalities in response to a request from a human, or automatically without human intervention.

Although one user client device 100, picker client device 110, and source computing system 120 are illustrated in FIG. 1A, any number of users, pickers, and sources may interact with the online system 140. As such, there may be more than one user client device 100, picker client device 110, or source computing system 120.

The user client device 100 is a client device through which a user may interact with the picker client device 110, the source computing system 120, the online system 140, or any other components of the system environment. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

In one or more embodiments, a user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

In one or more embodiments, the user uses the user client device 100 to report one or more errors with a completed order. In such embodiments, the user client device 100 may present an interface with one or more input options for the user to provide information on the one or more errors. The interface may further present content associated with processing the report, e.g., a status of the error processing, a resolution of the error, etc. The interface may further present a communication platform for the user to communicate with an agent (e.g., human or autonomous) remediating the error.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 can view orders presented by the online system 140 for the picker to select for servicing. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

Upon collection of the items, the picker client device 110 may instruct a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 notifies one or more pickers of available orders for servicing. The pickers, via their picker client device 110, may select or request to service an order from the available set. Upon approval by the online system 140, the online system 140 may transmit the user's order to the picker client device 110 associated with the picker. To service the order, the picker collects the ordered items from a source location and delivers the ordered items to the user. The online system 140 may charge a user for the order and provide portions of the payment from the user to the picker and the source.

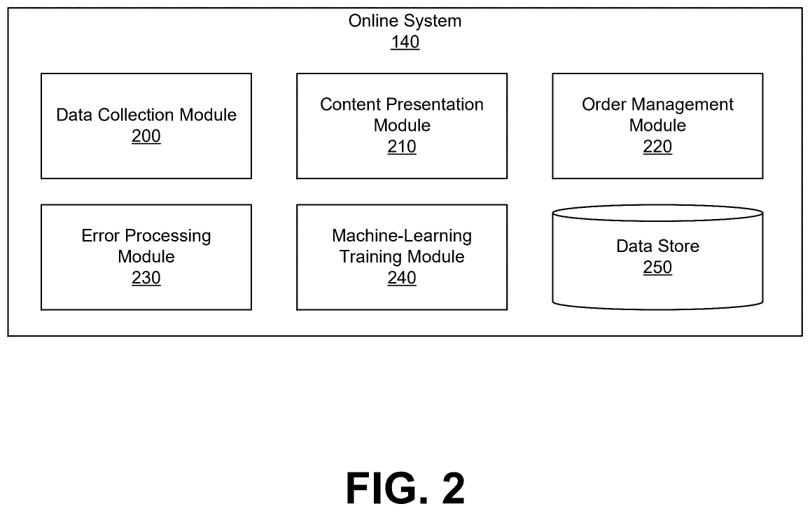

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In other embodiments, the transformer architecture may have an encoder-decoder architecture and includes a set of encoders coupled to a set of decoders. An encoder or decoder may include one or more attention operations.

While a LLM with a transformer-based architecture is described in connection with one or more embodiments, it is appreciated that in other embodiments the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a user client device 100, a picker client device 110, a source computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 or the interface system 160 is managed by a separate entity from the online system 140. In one or more embodiments, as illustrated in the example system environment in FIG. 1B, the model serving system 150 or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, an error processing module 230, a machine-learning training module 240, and a data store 250. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 250. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 250.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

In one or more embodiments, the content presentation module 210 generates one or more interfaces for processing errors with orders, i.e., following order completion. In some embodiments, the user client device 100 has an option to report any errors to the online system 140. Upon selection, the content presentation module 210 may present an interface for submitting information relating to any errors with the completed order. The interface may include at least an option to capture one or more images of the items that relate to the errors with the completed order. The interface may further include an input option to indicate the type of error, e.g., a multiple-choice selection for different types of common errors. As the error is resolved, the interface may further present content relating to the error resolution process.

In some embodiments, the content presentation module 210 generates an interface to a reviewer verifying the errors reported or identified prior to performing remedial actions to resolve the errors. In such embodiments, the interface presented to the reviewer may summarize the information submitted by the user, and may further include results of analyses to verify the errors or candidate remedial actions identified from the errors. The interface may present an option to select one of the candidate remedial actions to resolve the error.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. At such time, the order management module 220 may transmit instructions for proceeding with delivery of the order. For example, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

The error processing module 230 processes errors with orders. In one or more embodiments, the processing errors may entail identifying any errors from information submitted by the user, verifying any errors reported by the user based on information submitted by the user, engaging a human reviewer for approval or input, identifying candidate remedial actions to resolve the errors, performing one or more of the remedial actions, or some combination thereof.

In one or more embodiments, the error processing module 230 identifies any errors from one or more images of items in a completed order leveraging a language model. In such embodiments, the user client device 100 transmits one or more images of items that the user believes to be in err compared to their submitted order. The error processing module 230 may leverage a feature extraction model to identify image features from the images. The feature extraction model may leverage various computer vision algorithms to identify the image features. In one or more examples, the feature extraction model may leverage an item detection model to identify which item is present in the image. The item detection model may be trained on a training set of items in an item database. Accordingly, the item detection model may identify which item in the item catalog is captured in an image. The feature extraction model may further leverage an optical character recognition (OCR) algorithm to extract text from the image. The text extracted from objects in the image could help to identify the items in the image. The extracted text could also represent characteristics of that particular item obtained and provided in the user's order. For example, the extracted text could represent the item's best-by date or expiration date, the item's sizing, the item's name, the item's ingredient list, the item's nutrition facts. In one or more embodiments, the feature extraction model may further identify characteristics of variable items, e.g., ripeness of produce, spoilage of produce, damaged packaging, etc.

The error processing module 230 generates a prompt including the image features and instructions to identify any errors from the attached information. The prompt may further include the one or more images. The prompt's instructions may further include a request to identify one or more candidate remedial actions to resolve any identified errors. The error processing module 230 provides the prompt for execution by a language model (e.g., an LLM), resulting in a response by the language model. In some embodiments, the language model may be a multimodal model. In some embodiments, the language model performs retrieval-augmented generation by referencing a database of images labeled with different errors. The error processing module 230 parses the response to identify the errors identified from the information submitted by the user client device 100.

In one or more embodiments, the error processing module 230 verifies reported images based on one or more images of items submitted by the user client device 100. For example, the user client device 100 may indicate that an item in the completed order is not what was ordered, including an image of the allegedly unrequested item. The error processing module 230 may leverage the feature extraction model to identify image features from the images. The error processing module 230 generates a prompt including the image features and instructions to verify the reported errors based on the attached information. The prompt may further include the one or more images. The prompt's instructions may further include a request to identify one or more candidate remedial actions to resolve any identified errors. The error processing module 230 provides the prompt for execution by the language model, resulting in a response by the language model. The response may indicate a binary prediction of whether the reported errors are verified based on the supporting information. The response may also indicate a confidence score associated with the reported errors, e.g., a high confidence score indicates a higher likelihood that the reported errors are true errors and not fraudulent, whereas a low confidence score indicates a low likelihood that the reported errors are true errors. The error processing module 230 parses the response to verify or to invalidate the reported errors.

In some embodiments, the error processing module 230 may engage a human reviewer to provide feedback on input on the error resolution process. The error processing module 230 may generate a report presenting the information submitted by the user client device 100 and further including any results of analyses performed by the error processing module 230, e.g., identified errors, verified errors, candidate remedial actions, or some combination thereof. The report may request the human reviewer to provide input on whether to approve remedial actions or input on what remedial actions to undertake in resolving any errors.

In some embodiments, the error processing module 230 may autonomously perform one or more of the remedial actions. The error processing module 230 may leverage a decisioning system to select the remedial action to undertake, based on a remedial policy constraining what actions may be taken for each issue. The decisioning system may further leverage historical data, e.g., on the general user populace, or the particular user, to tailor the remedial actions for the particular context. Example remedial actions to resolve the errant order with the user include submitting a new order to correct one or more of the missed items in the order, recovering some portion of the order's payment attributed to the error, issuing a credit covering some portion of the order's payment attributed to the error, providing a coupon or a discount for a follow-up order, etc. The error processing module 230 may leverage an autonomous agent to autonomously perform one or more of the remedial actions.

In one or more embodiments, the error processing module 230 may identify patterns contributing to recurrent error types for performing preventative measures to identify or remedy such errors before order completion. For example, the error processing module 230 may identify a recurrent error type affecting one source location more than others. The error processing module 230 may generate a notification to the source computing system 120 to further investigate the cause of the higher-than-average frequency in that error type. The error processing module 230, in other embodiments, may identify certain error types that a picker is prone to. In such embodiments, the error processing module 230 may perform preventative measures to prophylactically address errors before order delivery. For example, the error processing module 230 may generate one or more notifications to remind the picker to check for the recurrent error types, prior to delivery.

The machine-learning training module 240 trains machine-learning models used by the online system 140. For example, the machine learning module 230 may train the item selection model, the availability model, or any of the machine-learned models deployed by the model serving system 150. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 240 generates the set of parameters (e.g., the particular values of the parameters) for a machine-learning model by “training” the machine-learning model. Once trained, the machine-learning model uses the set of parameters to transform inputs into outputs.

The machine-learning training module 240 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 240 may apply an iterative process to train a machine-learning model whereby the machine-learning training module 240 updates parameter values of the machine-learning model based on each of the set of training examples. The training examples may be processed together, individually, or in batches. To train a machine-learning model based on a training example, the machine-learning training module 240 applies the machine-learning model to the input data in the training example to generate an output based on a current set of parameter values. The machine-learning training module 240 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 240 updates the set of parameters for the machine-learning model based on the score generated by the loss function. For example, the machine-learning training module 240 may apply gradient descent to update the set of parameters.

In some embodiments, the machine-learning training module 240 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 240 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

In one or more embodiments, the machine-learning training module 240 may tune a language model to perform image-based error identification or verification. In such embodiments, the machine-learning training module 240 may obtain training data from historical orders with errors that were verified, e.g., by a human reviewer. Each of the historical orders may include images taken by a user client device 100 and submitted with the report of such errors. The machine-learning training module 240 may apply the feature extraction model 310 to the images to extract image features from the images. Each of the historical orders can serve as a training example to tune the language model to identify similar errors in subsequent orders. The machine-learning training module 240 may further tune the language model to identify appropriate remedial actions for each identified error. For example, the machine-learning training module 240 may identify, from the historical orders, which remedial actions were undertaken to resolve errors. The identified remedial actions for each type of error can be used as training examples to tune the language model to recommend appropriate remedial actions with novelly-identified errors from images.

The machine-learning training module 240 may fine tune the language model based on feedback to the model's responses. In embodiments with identifying or verifying errors from images of items in a completed order, the machine-learning training module 240 may obtain feedback from users of the identified errors. The feedback can concur with the identified or verified errors, or can disagree with such identification. The machine-learning training module 240 may generate positive training examples with predictions corroborated by the user, or negative training examples with predictions contested by the user. In other embodiments with the language model identifying candidate remedial actions to resolve an error, the machine-learning training module 240 may obtain eventual results of the resolved errors. For example, if the user provided feedback that they were unsatisfied by the resolution, the machine-learning training module 240 may generate a negative training example based on that feedback. The complement would go for feedback indicating the resolution was satisfactory. The machine-learning training module 240 leverages these additional training examples to perform fine tuning (i.e., retraining) of the language model. In fine tuning, the machine-learning training module 240 trains the language model to further bias outputs towards the positive training examples or biasing outputs away from the negative training examples.

The data store 250 stores data used by the online system 140. For example, the data store 250 stores user data, item data, order data, and picker data for use by the online system 140. The data store 250 also stores trained machine-learning models trained by the machine-learning training module 240. For example, the data store 250 may store the set of parameters for a trained machine-learning model on one or more non-transitory, computer-readable media. The data store 250 uses computer-readable media to store data, and may use databases to organize the stored data.

With respect to the machine-learned models hosted by the model serving system 150, the machine-learned models may already be trained by a separate entity from the entity responsible for the online system 140. In other embodiments, when the model serving system 150 is included in the online system 140, the machine-learning training module 240 may further train parameters of the machine-learned model based on data specific to the online system 140 stored in the data store 250. As an example, the machine-learning training module 240 may obtain a pre-trained transformer language model and further fine tune the parameters of the transformer model using training data stored in the data store 250. The machine-learning training module 240 may provide the model to the model serving system 150 for deployment.

### Image-Based Error Processing With a Language Model

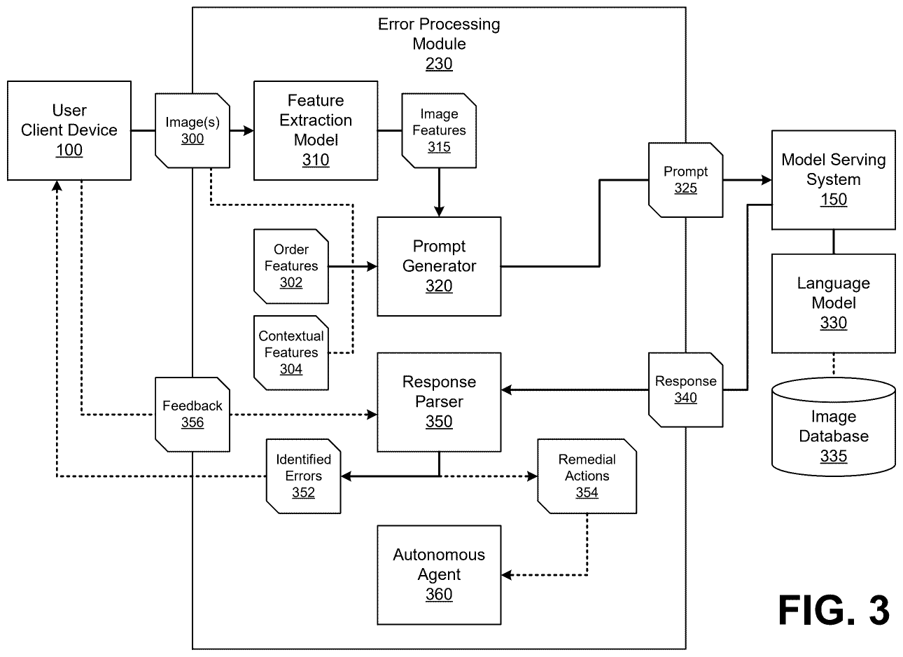

FIG. 3 illustrates an interaction diagram describing the process of image-based error identification and, optionally, remediation, in accordance with one or more embodiments. Alternative embodiments may include more, fewer, or different steps from those illustrated in FIG. 3, and the steps may be performed in a different order from that illustrated in FIG. 3. These steps may be performed by various components of the system environment described in FIG. 1. Additionally, each of these steps may be performed automatically by the online system without human intervention.

The user client device 100 transmits an indication to the online system 140 that there is an issue with a completed order. There may be an option in the user interface presented on the user client device 100 to provide information relating to the issue. In one or more embodiments, the user client device 100 may be prompted to capture images of the items in the completed order that the user thinks are at issue. The user client device 100 may capture the images 300 with a camera assembly implemented on the user client device 100.

A feature extraction model 310 implemented by the error processing module 230 may extract image features 315 from the images 300. For example, the feature extraction model 310 may identify which items are captured in the images 300 using an image classification model. The feature extraction model 310 may also leverage OCR algorithms to recognize text on the items, e.g., describing characteristics of the item. The feature extraction model 310 may also predict different physical characteristics of the item, e.g., ripeness of produce, spoilage of produce, damage on product packaging, etc.

A prompt generator 320 generates a prompt 325 for identifying errors based on the images 300. The prompt generator 320 may generate the prompt 325 to include the image features 315 and order features 302 with instructions to identify errors based on the inputs. In some embodiments, the prompt 325 may be multimodal further including the images 300, or portions of the images relating to any items identified in the images 300. The prompt 325 may further include other contextual features 304, e.g., relating to the user, relating to the picker who serviced the order, relating to the source location, etc. The instructions may further request identifying remedial actions that can be taken to address any identified errors. The instructions may further request that the language model 330 outputs a confidence score associated with any identified error, indicating a confidence in the model's prediction of the identified error. In one or more example implementations, the prompt 325 states:
“Identify any errors with the order based on the attached order and the characteristics of this item captured in this photo by the user, including: [list of extracted image features].”
   The list of extracted image features 315 may be listed in the populatable field [list of extracted image features]. The prompt 325 may further attach details regarding the order, i.e., the order features 302, e.g., specifying the items included in the submitted order, specifying the items obtained by the picker in servicing the order, etc. The prompt 325 may also append the images or portions thereof.

The prompt generator 320 provides the prompt 325 to the model serving system 150 for execution of the prompt by the language model 330. The language model 330 may be tuned to identify errors based on the input image features 315, the images 300, the order features 302, the contextual features 304, or some combination thereof. In one or more embodiments, the language model 330 may be further tuned to identify remedial actions to remediate any identified errors, i.e., based on the inputs. In one or more embodiments, the language model 330 may refer to a reference database 335 with image features or reference images labeled with different error types as a guide to identifying errors in the prompt 325. In such embodiments, the language model 330 may implement retrieval-augmented generation (RAG) with the labeled data in the reference database 335.

Following execution by the language model 330, the language model 330 returns a response of any identified errors. For example, the response may state:
“Based on the attached order and the characteristics of this item captured in a photo by the user, it appears that the product packaging is damaged in the bottom left corner.”
   A response parser 350 of the error processing module 230 may parse the response to identify error types relating to the item identified in the photo. For example, the response parser 350 may, based on the above example response, identify that the item has an error type of damaged product packaging. The response parser 350 may identify other error types, e.g., produce is spoiled, product is past best-by date or expiration date, incorrect item, incorrect sizing or quantity of item, etc.

The response 340 may further indicate remedial actions 354. For example, the response 340 may further state:
“In light of the damaged product packaging, resolutions may include:
1. Refunding the cost of the item.
2. Issuing credit for the item.
3. Delivering a replacement.
   The response parser 350 may parse the text response 340 to identify the actions that can be taken to resolve the identified error. The response parse 350 may parse out any candidate remedial actions provided for each identified error.

In one or more embodiments, the error processing module 230 may request confirmation of any identified error by the user. In some embodiments, the error processing module 230 may provide a notification of the identified errors 352 to the user client device 100. The user interface on the user client device 100 may present the identified errors with an option to approve or to reject the identified errors. The user interface may transition through the different errors identified. For example, the user interface may present a text caption next to the image 300 captured by the user:
“Based on this image, we've identified that the product packaging may be damaged. Is this right?”
   The user interface may further include options for user input to approve or to reject the identified errors. If the user rejects the identified errors, then the user interface may further include an input option for the user to indicate what they think the issue is with the item. The user's input or feedback to the image-based error identification may be leveraged in fine tuning (i.e., retraining) the language model 330.

In some embodiments, the error processing module 230 may employ an autonomous agent 360 to automatically perform one or more of the remedial actions 354 suggested by the language model 330. The autonomous agent 360 may select one of the remedial actions 354 to perform based on a decisioning policy that includes heuristics to constrain what actions can be taken for each error type. In some embodiments, the autonomous agent 360 may provide an option to the user to select their preferred remedial action. For example, the autonomous agent 360 may transmit the various remedy options to present to the user via the user interface presented on the user client device 100. Based on the user's selection, the autonomous agent 360 may automatically perform the selected remedial action. For example, this could entail issuing a refund for a portion of the order attributable to the error.

In one or more embodiments, the error processing module 230 may request confirmation of any identified error by a human reviewer. The error processing module 230 may have one or more triggering criteria to loop in the human reviewer. For example, one criterium is if the error processing module 230 identifies no errors or only identifies errors with a low confidence. In such instances, if that criterium is triggered, the error processing module 230 may generate a report for the human reviewer including the images 300 provided by the user, and the identification of no errors or low-confidence errors. The report may be transmitted to a client device of the human reviewer with options to approve or to reject any low-confidence errors or to manually identify errors from the images 300. The human reviewer's input or feedback to the image-based error identification may be leveraged in fine tuning (i.e., retraining) the language model 330.

The workflow described in FIG. 3 streamlines the workflow of reporting errors with a completed order. The workflow empowers the user to begin with capturing a photo of items at issue, then leveraging the language model 330 to identify any errors in the items. Such inference compacts the review process, without sacrificing robustness in preventing fraudulent error reports. Also, leveraging the feature extraction model 310 can identify physical traits or characteristics of one or more items captured in the images 300, to leverage such information in identifying any errors. Moreover, implementing an autonomous agent 360 to perform one or more of the remedial actions further automates the error resolution process.

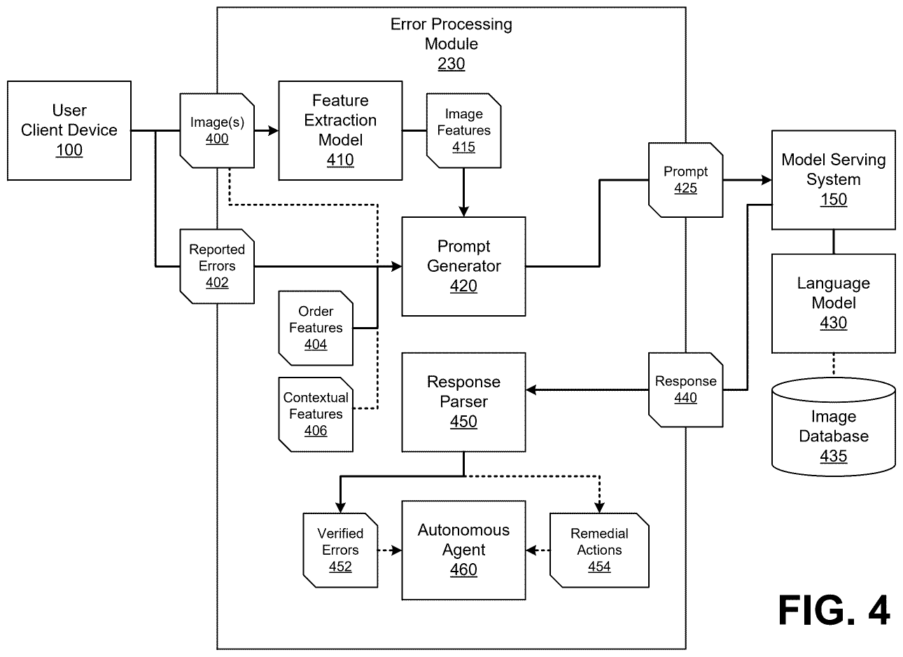

FIG. 4 illustrates an interaction diagram describing the process of image-based error verification and, optionally, remediation, in accordance with one or more embodiments. Alternative embodiments may include more, fewer, or different steps from those illustrated in FIG. 4, and the steps may be performed in a different order from that illustrated in FIG. 4. These steps may be performed by various components of the system environment described in FIG. 1. Additionally, each of these steps may be performed automatically by the online system without human intervention. FIG. 4 shares one or more principles with FIG. 3, accordingly, functionality described above with respect to FIG. 3 may apply in the interaction diagram of FIG. 4.

In some embodiments, the user client device 100 preemptively indicates errors in the order, i.e., reported errors 402, and further submits images 400 to support the reported errors 402. The error processing module 230 leverages the language model 430 for image-based verification of the reported errors 402. In such embodiments, the inference task is focused on ascertaining whether the provided images provide adequate support for the reported errors 402. In some embodiments, the user interface presented on the user client device 100 may initially prompt the user to indicate an error type with the completed order. The user interface may also prompt the user to capture one or more images 400 to support the reported errors 402.

The feature extraction model 410 extracts image features 415 from the images 400. The prompt generator 420 generates a prompt 425 including the reported errors 402, the order features 404, and the image features 415 with instructions to verify whether the image features 415 support the reported errors 402. For example, the prompt 425 may state:
“Based on the attached order and the characteristics of this item captured in this photo by the user, including: [list of extracted image features], please verify the presence of: [reported error].”
   The reported error 402 may be populated into the populatable field [reported error]of the prompt 425. The prompt 425 instructions may further request a confidence score with the verification. The prompt 425 instructions may further request identifying remedial actions to resolve any verified errors.

Following execution by the language model 430 (in some embodiments, leveraging the reference database 435), the error processing module 230 receives a response 440 output by the language model 430. The response may indicate whether the reported errors 402 are verified or not. The response parser 450 may parse the text response 440 to identify any verified errors 452, and, in some embodiments, any remedial actions 454 to address verified errors 452. In some embodiments, if the language model 430 rejects the reported errors 402, or provides a low-confidence score, the error processing module 230 may generate a report for human review of the reported errors 402.

In some embodiments, the error processing module 230 may identify a recurrent pattern of rejected errors reported by the user client device 100 associated with a user profile. The error processing module 230 may infer such a pattern is suspected fraudulent activity. In such embodiments, the error processing module 230 may generate a report of the suspected fraudulent activity for review by a human reviewer. Following confirmation by the human reviewer, the error processing module 230 may suspend the user's account, or perform other disciplinary action.

In one or more embodiments, if the reported errors 402 are rejected on the basis of the images 400 currently provided, the error processing module 230 may prompt the user client device 100 to capture additional image data, or to suggest corrections to the reported errors. For example, the user interface of the client device 110 may state:
“Mhm, from the photos, it doesn't seem like the pear is spoiled. Would you like to submit another photo?”
   This would request the user to take another photo. The user client device 100 may capture and provide additional images to the error processing module 230 for verification. In another example, the user interface of the user client device 100 may state:
“Mhm, from the photos, it doesn't seem like the packaging is damaged. Did you mean to indicate that the item is past its best-by date?”
   In such embodiments, the language model 430 may have identified different error types in the images 400, rather than the reported errors 402. The user interface may further present options to accept or to reject the modification to the reported errors 402.

Following verification, the error processing module 230 may perform the one or more remedial actions 454, e.g., pending approval by a human reviewer. An autonomous agent 460 may perform one or more of the remedial actions 454.

### Example Methods

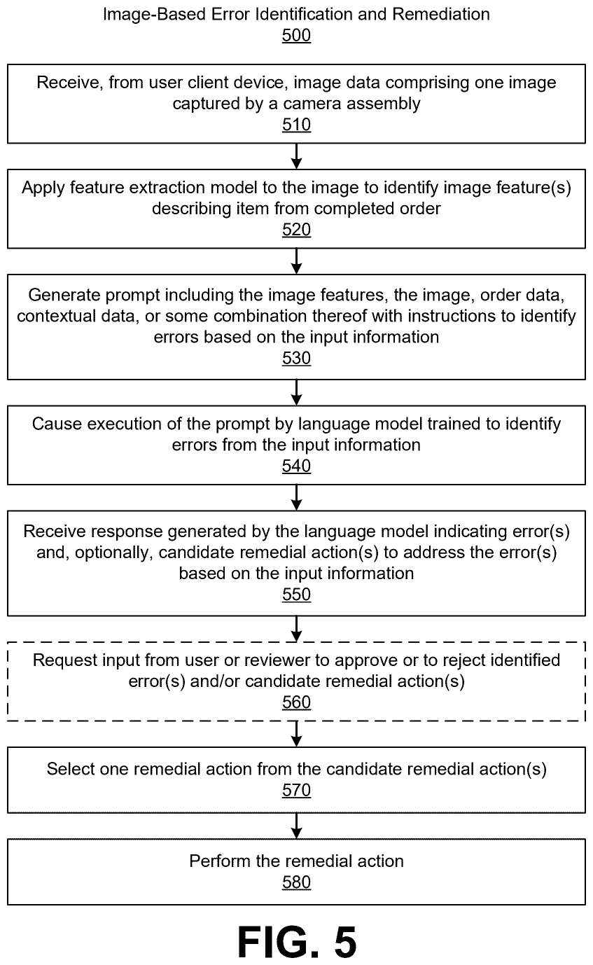

FIG. 5 illustrates a method flowchart of the process 500 of image-based error identification and remediation, in accordance with one or more embodiments. Alternative embodiments may include more, fewer, or different steps from those illustrated in FIG. 5, and the steps may be performed in a different order from that illustrated in FIG. 5. These steps may be performed by an online system (e.g., online system 140). Additionally, each of these steps may be performed automatically by the online system without human intervention.

The online system receives 510, from a computing device, image data including one image captured by a camera assembly. In some embodiments, the online system receives a request to report one or more errors. Based on the request, the online system may prompt the user to capture the image data with the camera assembly. In some embodiments, the system further receives, from the computing device, information describing one or more reported errors associated with the image data.

The online system applies 520 a feature extraction model to the image to identify image features describing an item from a completed order. The feature extraction model may comprise an item detection model trained on images of items in an item database to identify the item from the completed order captured in the image. In some embodiments, the feature extraction model may comprise an optical character recognition algorithm to identify text on the item from the completed order captured in the image, wherein the one or more image features include the identified text on the item.

The online system generates 530 a prompt including the image features, the image (or a portion thereof), order data, contextual data, or some combination thereof and instructions to identify any errors with the item from the completed order. In some embodiments, the system generates the prompt to include the image of the item. In some embodiments, the system generates the prompt with the instructions to identify one or more candidate remedial actions for each identified error. The system may generate the prompt to further include other contextual information, e.g., order data indicating items requested in an order request and items obtained in the completed order.

The online system causes 540 execution of the prompt by a language model trained as a machine-learning model to perform error identification based on image features. The language model is trained by: obtaining historical orders each with one or more errors identified by a human reviewer and historical image data of items associated with the one or more errors; applying the feature extraction model to historical images in the historical image data to identify a set of image features for each historical image; generating a plurality of training examples comprising the sets of image features and the one or more errors identified; and training the language model with the plurality of training examples to perform error identification based on image features. In some embodiments, the system receives feedback on the one or more errors identified from the response generated by the language model; generates training examples with the image data and the feedback; and retrains the language model with the training examples. In some embodiments, the system configures the language model to perform retrieval-augmented generation by referencing a database including a plurality of reference images each labeled with one or more errors.

The online system receives 550 a response generated by the language model indicating errors identified from the image features. In some embodiments, where the prompt specifies the reported error, the response may verify or reject each error. In some embodiments, the response includes one or more candidate remedial actions for each identified error. The system may also receive feedback on the one or more candidate remedial actions generated by the language model, for use in retraining the language model.

The online system selects 560 one remedial action from candidate remedial actions to resolve the identified errors. Candidate remedial actions may be associated with each type of error. In some embodiments, the system uses a selection algorithm to identify which remedial action to undertake. In some embodiments, the online system may notify the user of any identified errors from the image for the user to confirm the errors. In other embodiments, the online system may notify the user of candidate remedial actions, from which the user may select one of such remedial actions to resolve an identified error.

The online system performs 570 the remedial action to resolve the errors identified by the language model. In one or more embodiments, the online system may transmit the reported errors to the computing device, for presentation to the user. Other remedial actions may include generating a replacement order for correcting one or more missed items, providing a refund for any missed items, etc.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, from a computing device, a request to report one or more errors with a completed order and image data comprising one image captured by a camera assembly coupled to the computing device;
applying a feature extraction model to the image to identify one or more image features describing an item from the completed order captured in the image;
generating a prompt including the image features and instructions to identify any errors with the item from the completed order;
causing execution of the prompt by a language model trained as a machine-learning model to perform error identification based on image features;
receiving a response generated by the language model upon execution of the prompt indicating one or more errors identified from the image features;
responsive to the response indicating the one or more errors, selecting one or more candidate remedial actions to resolve the one or more errors; and
performing, with an autonomous agent, one of the remedial actions comprising transmitting a notification to the computing device of the identified one or more errors.

2. The method of claim 1, further comprising:
responsive to the request, providing a prompt to capture the image data via the camera assembly coupled to the computing device,
wherein receiving, from the computing device, the image data follows providing the prompt.

3. The method of claim 2, further comprising:
receiving, from the computing device, information describing one or more reported errors associated with the image data,
wherein generating the prompt comprises generating the prompt with instructions to verify the one or more reported errors based on the image features extracted from the image data, and
wherein receiving the response generated by the language model comprises receiving the response further verifying or invalidating each reported error.

4. The method of claim 1, wherein the language model is trained by a process comprising:
obtaining historical orders each with one or more errors identified by a human reviewer and historical image data of items associated with the one or more errors;
applying the feature extraction model to historical images in the historical image data to identify a set of image features for each historical image;
generating a plurality of training examples comprising the sets of image features and the one or more errors identified; and
training the language model with the plurality of training examples to perform error identification based on image features.

5. The method of claim 4, further comprising:
receiving feedback on the one or more errors identified from the response generated by the language model;
generating training examples with the image data and the feedback; and
retraining the language model with the training examples.

6. The method of claim 1, wherein applying the feature extraction model comprises applying an item detection model trained on images of items in an item database to identify the item from the completed order captured in the image.

7. The method of claim 6,
wherein applying the feature extraction model comprises applying an optical character recognition algorithm to identify text on the item from the completed order captured in the image, wherein the one or more image features include the identified text on the item; and
wherein generating the prompt comprises generating the prompt to include the identified text on the item.

8. The method of claim 1, wherein generating the prompt comprises generating the prompt to include the image of the item.

9. The method of claim 1,
wherein generating the prompt comprises generating the prompt with the instructions to identify one or more candidate remedial actions for each identified error,
wherein receiving the response generated by the language model comprises receiving the response indicating the one or more candidate remedial actions for each identified error, and
wherein selecting the one or more candidate remedial actions to resolve the one or more errors comprises selecting the one or more candidate remedial actions from the response.

10. The method of claim 9, further comprising:
receiving feedback on the one or more candidate remedial actions identified from the response generated by the language model;
generating training examples with the image data and the feedback; and
retraining the language model with the training examples.

11. The method of claim 1, further comprising:
obtaining order data associated with the completed order, wherein the order data describes items requested in an order request and items obtained in the completed order,
wherein generating the prompt comprises generating the prompt to include the order data with the instructions to identify any errors with the item from the completed order further based on the order data.

12. The method of claim 1, wherein causing the execution of the prompt by the language model comprises causing the execution of the prompt by implementing retrieval-augmented generation by referencing a database including a plurality of reference images each labeled with one or more errors.

13. The method of claim 1, wherein receiving the response generated by the language model comprises receiving the response indicating the errors as candidate errors, the method further comprising:
providing, to the computing device, the candidate errors for presentation on the computing device; and
receiving, from the computing device, a selection of one of the candidate errors as associated with the item from the completed order captured in the image,
wherein selecting the one or more remedial actions comprises selecting the one or more remedial actions to address the selected error.

14. The method of claim 1, further comprising:
providing, to the computing device, the one or more candidate remedial actions for presentation to a user operating the computing device; and
receiving, from the computing device, a selection of one of the candidate remedial actions,
wherein performing the one remedial action comprises performing the selected remedial action.

15. A non-transitory computer-readable storage medium storing instructions that, when executed by a processor, cause the processor to perform operations comprising:
receiving, from a computing device, a request to report one or more errors with a completed order and image data comprising one image captured by a camera assembly coupled to the computing device;
applying a feature extraction model to the image to identify one or more image features describing an item from the completed order captured in the image;
generating a prompt including the image features and instructions to identify any errors with the item from the completed order;
causing execution of the prompt by a language model trained as a machine-learning model to perform error identification based on image features;
receiving a response generated by the language model upon execution of the prompt indicating one or more errors identified from the image features;
responsive to the response indicating the one or more errors, selecting one or more candidate remedial actions to resolve the one or more errors; and
performing, with an autonomous agent, one of the remedial actions comprising transmitting a notification to the computing device of the identified one or more errors.

16. The non-transitory computer-readable storage medium of claim 15, the operations further comprising:
responsive to the request, providing a prompt to capture the image data via the camera assembly coupled to the computing device,
wherein receiving, from the computing device, the image data follows providing the prompt.

17. The non-transitory computer-readable storage medium of claim 16, the operations further comprising:
receiving, from the computing device, information describing one or more reported errors associated with the image data,
wherein generating the prompt comprises generating the prompt with instructions to verify the one or more reported errors based on the image features extracted from the image data, and
wherein receiving the response generated by the language model comprises receiving the response further verifying or invalidating each reported error.

18. The non-transitory computer-readable storage medium of claim 15, wherein the language model is trained by a process comprising:
obtaining historical orders each with one or more errors identified by a human reviewer and historical image data of items associated with the one or more errors;
applying the feature extraction model to historical images in the historical image data to identify a set of image features for each historical image;
generating a plurality of training examples comprising the sets of image features and the one or more errors identified; and
training the language model with the plurality of training examples to perform error identification based on image features.

19. The non-transitory computer-readable storage medium of claim 18, the operations further comprising:
receiving feedback on the one or more errors identified from the response generated by the language model;
generating training examples with the image data and the feedback; and
retraining the language model with the training examples.

20. A system comprising
a computer processor; and
a non-transitory computer-readable storage medium storing instructions that, when executed by the processor, cause the computer processor to perform operations comprising:
receiving, from a computing device, a request to report one or more errors with a completed order and image data comprising one image captured by a camera assembly coupled to the computing device;
applying a feature extraction model to the image to identify one or more image features describing an item from the completed order captured in the image;
generating a prompt including the image features and instructions to identify any errors with the item from the completed order;
causing execution of the prompt by a language model trained as a machine-learning model to perform error identification based on image features;
receiving a response generated by the language model upon execution of the prompt indicating one or more errors identified from the image features;
responsive to the response indicating the one or more errors, selecting one or more candidate remedial actions to resolve the one or more errors; and
performing, with an autonomous agent, one of the remedial actions comprising transmitting a notification to the computing device of the identified one or more errors.
